(19) United States
(12) Patent Application Publication
(10) Pub. No.: US 2026/0094539 A1
(43) Pub. Date: Apr. 2, 2026

(54) Tensegrity Structure Components Thereof

(71) Applicant: Michael Oleon, Chicago, IL (US)

(72) Inventor: Michael Oleon, Chicago, IL (US)

(21) Appl. No.: 18/927,344

(22) Filed: Oct. 25, 2024

Related U.S. Application Data
(60) Provisional application No. 63/593,179, filed on Oct. 25, 2023.

(51) Int. Cl. G09B 23/34

(52) U.S. Cl. CPC G09B 23/34

(57) ABSTRACT

The invention introduces a novel method for constructing tensegrity structures using unique connection members equipped with multiple receiving sockets and anchoring components, streamlining the assembly process. This design emphasizes secure junctions, versatile configurations, tool-free assembly and disassembly, and varying prestress of tensile spans, especially in irregular tensegrity forms.

### RELATED APPLICATION

This patent application claims the benefit of priority to U.S. Provisional Ser. No. 63/593,179, which was filed on Oct. 25, 2023. U.S. Provisional Ser. No. 63/593,179 is hereby incorporated herein by reference in its entirety.

### BACKGROUND

The present invention pertains to the field of modular structural design and, more particularly, to tensegrity structures. Examples disclosed herein also provide a method of assembling tensegrity structures including adjustable tension members, compression members, and a connection node. In some examples, the tensegrity structures and the method of assembly associated therewith do not utilize tools or additional fastening elements in order to couple the tension members to the connection node.

Tensegrity construction is intricate. Prior assembly methods typically involve making errors and necessitating backtracking. As assembly progresses, increased stress within the structure can eject struts unless capped regularly. Remedying an obstructed tension member is time-consuming and error-prone.

Tensegrity structures are commonly built using slotted sticks and elastic bands as compression and tension members. This method is suitable for simple, symmetrical designs but prone to deformation in irregular polygonal structures due to uneven stress loads. Tension members often overlap one another at their attachment point on the compression member, which alters the length of the spans, and applies uneven stress, leading to unpredictable and accelerated deformation over the lifespan of the structure.

Some methods avoid the challenges of overlapping tension members by fastening the tensile spans to connecting members in a pre-tensioned lattice, requiring individual fasteners such as a knot or screw for each span-end.

Still another method uses subtractive technology on elastomeric sheets, such as silicone, which produces tension lattices with overlapping span ends. This method is limited to regular structures, since spans of differing lengths require differing levels of pre-tension. Thus, these structures are subject to uneven, accelerated deformation of the structure.

Prior assembly methods are not user-friendly for novice tensegrity designers. These methods often require tools or additional fastening elements in order to hold the tension and compression members in place. The resulting structures are typically limited to regular polygonal forms and do not have an aesthetically pleasing appearance.

### SUMMARY OF THE INVENTION

The primary objective of this assembly method is to facilitate the construction of a tensegrity structure including a tool-free, one step connection that eliminates, or otherwise reduces, the need for additional fastening techniques. This objective is accomplished by a connection node and anchoring members described herein. In one embodiment, the connection node hosts a number of evenly spaced receiving sockets and a central vertical channel. The anchoring member, which is the primary connecting element of the tensile span, may be prismatic in shape and designed to fit snugly within the receiving sockets allowing for a tool free, interference-fit connection. This connection keeps the anchoring member firmly in place and guarantees stability during and after assembly. This tool free connection also allows for easy removal of the anchoring members.

Another objective of this assembly method is to allow non-experts to construct intricate tensegrity configurations. This objective is accomplished through the user-friendly design of the connection node and anchoring members. The interference fit connection allows for the flexible tension spans to be detached and reattached without affecting the connectivity of the other spans. Additionally, these flexible spans allow for the assemble of irregular polygonal forms including organic models.

In one example embodiment, the tensegrity structure is comprised of a compression member having a central axis, a tensile member including an anchor, and a connection node. The connection node is comprised of a first surface, a second surface contiguous with the first surface, and a socket to receive an end of the tensile member to couple the connection node and the tensile member via an interference fit.

As used herein, an “interference fit” encompasses a fit between two parts in which the external dimension of one part are equivalent to or slightly exceeds the internal dimension of the part into which it has to fit. As such, the external dimensions of the end of the tensile member are equivalent to or slightly exceed the internal dimensions of the socket. Thus, “interference fit” encompasses a press fit, a friction fit, a force fit, a tight fit, a shrink fit, and a transition fit.

The connection node is comprised of a plurality of sockets which are evenly distributed around a plane orthogonal to the central axis of the compression. The socket includes a first portion having a first width and a second portion having a second width greater than the first width. The greater width is measurable in a geometric plane parallel to the first surface. The first portion of the socket is defined in the first surface and the second surface. The second portion of the socket is defined in the first surface and not the second surface.

The second portion of the socket includes a curvature in a geometric plane orthogonal to a central axis of the connection node and wherein the curvature bends ends of the second portion of the socket towards the first portion of the socket. Given that the connection node is transverse to the orthogonal plane, the tensile member is included in the socket and this is also where the different accessories are included through the central axis.

In some embodiments, the connection node also has a snap-fit overhang extending from the first surface. The snap-fit overhang causes the second portion of the socket to have a first length at the first surface and a second length, greater than the first length, separated from the first surface. The snap-fit overhang of the receiving socket allows for a snap-fit connection so the need for additional fastening methods is not needed, which makes this a tool free invention for assembly and disassembly. This eases the process of making the tensegrity structure as well as making it more free of errors. This also allows for the tensile spans to be attached and detached from a connection node without affecting the other tensile spans.

In still further embodiments, the tensile members may have different prestress levels and this ensures the structural integrity of the irregular polyhedral configurations as well as regular polyhedral configurations. This snap-fit/interference fit also allows an individual to create diverse geometric configurations with a tailored stress distribution to ensure the structural stability and longevity of the tensegrity structure.

This invention is a method for enhancing the way tensegrity structures are created. Through the snap-fit overhang an interference fit connection is made, and this allows for a cleaner and easier assembly since the different pre-stressed tension members which can vary in length and levels of prestress are able to connect without overlapping. Having a plane orthogonal to the central axis and with the different features of the invention such as the sockets being evenly spaced out and the tensile members being coupled to it allows for different accessories to be attached to the invention.

This is a tool free invention since a fastener is not needed to couple the tensile spans to a connection node. This allows for easier assembly and disassembly when creating tensegrity structures. This allows for different levels of pre-stressed tensile members to be assembled together to create long lasting and structurally stable irregular tensegrity shapes.

### BRIEF DESCRIPTION OF THE DRAWINGS

The present invention is illustrated by way of example, and not by way of limitation, in the figures of the accompanying drawings

FIGS. 1 and 2 illustrate perspective views of example tensegrity structures.

FIG. 3 illustrates a perspective view of an example connection node coupled to tensile members to form a portion of a tensegrity structure.

FIG. 4 illustrates a perspective view of a further example connection node coupled to tensile members to form a portion of a tensegrity structure.

FIG. 5 illustrates a perspective view of an example connection node and an example tensile member to couple to the connection node.

FIG. 6 illustrates a cross-sectional view taken along lines 6-6 of the connection node of FIG. 5 coupled to the tensile member of FIG. 5.

FIG. 7 illustrates an isolated cross-sectional view taken along lines 7-7 of the connection node of FIG. 5.

FIG. 8 illustrates an isolated cross-sectional view taken along lines 8-8 of the tensile member of FIG. 5.

FIG. 9 is plan view of the connection between the tensile member and the connection node.

FIG. 10 is a plan view of another example tensile member including a hugging projection to further secure the connection to the connection node.

FIG. 11 illustrates an isolated perspective view of a further example connection node.

FIG. 12 illustrates a perspective cross-sectional view taken along lines 12-12 of the connection node of FIG. 11.

FIG. 13 illustrates a cross-sectional view of a portion of a tensegrity structure including a first example connection node coupled to a second example connection node.

FIG. 14 illustrates a cross-sectional view of an example coupling between a tensile member and respective ones of the connection node of FIGS. 11-13.

FIG. 15 illustrates an isolated perspective view of another example connection node.

FIG. 16 illustrates an example cross-sectional view taken along lines 16-16 of the connection node of FIG. 15.

FIG. 17 illustrates a further example cross-sectional view taken along lines 17-17 of the connection node of FIG. 15.

FIG. 18 illustrates a perspective view of a further example tensile member.

FIG. 19 illustrates a plan view of an example tensile web.

FIG. 20 illustrates a perspective view of an example floating connection node.

### DETAILED DESCRIPTION OF THE ILLUSTRATED EMBODIMENT

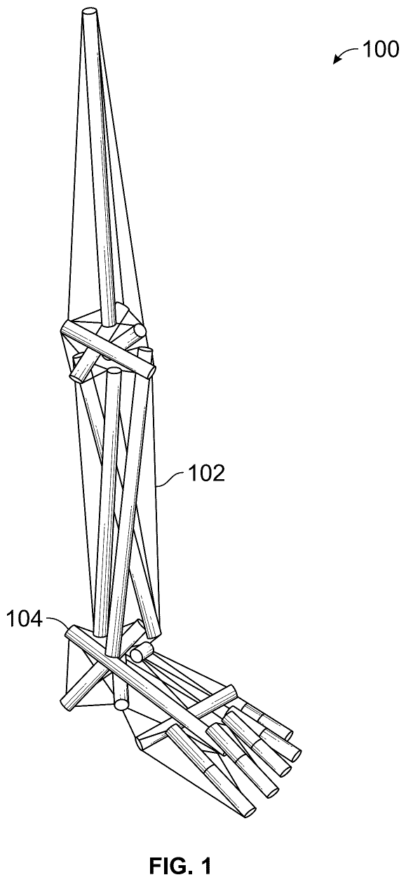

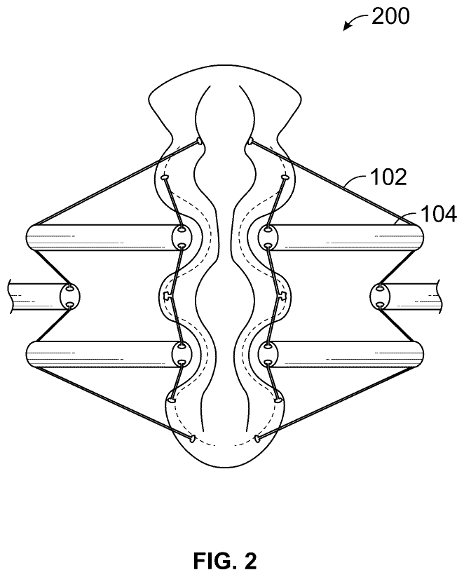

FIG. 1 illustrates an example tensegrity structure 100 in the form of a human foot and lower leg. FIG. 2 illustrates another example tensegrity structure 200 in the form of a human spine. The tensegrity structures 100, 200 include tensile members 102 that couple to compression members 104 via connection nodes, which are discussed in further detail below. As such, the compression members 104 are representative of bones, and the tensile members 102 are representative of connective tissues between the bones. Thus, the tensegrity structures 100, 200 can serve as useful tools in recreating (e.g., modeling) a musculoskeletal system. Although the tensegrity structures 100, 200 are recreations of the musculoskeletal system, it should be understood that the teachings disclosed herein are applicable to other types of tensegrity structures, such as those used in architecture, robotics, biochemistry, etc.

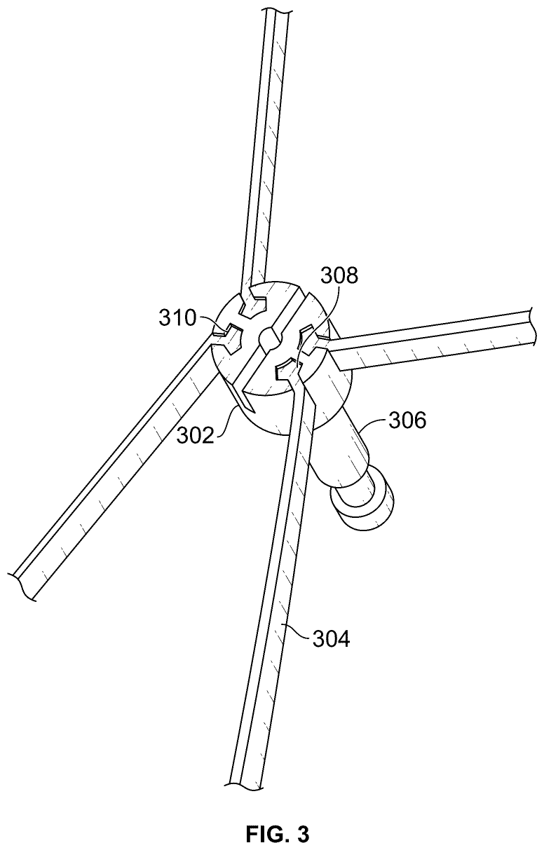

FIG. 3 illustrates an example connection node 302 coupled to tensile members 304 and a compression member 306 to form a portion of a tensegrity structure, such as the tensegrity structure 100 of FIG. 1 and/or the tensegrity structure 200 of FIG. 2. The connection node 302 is coupled to an end of the compression member 306. For example, the connection node 302 can be coupled to the end of the compression member 306 via a fastener. In some examples, the connection node 302 is coupled to the end of the compression member 306 in another manner, such as an interference fit. In some examples, the connection node 302 is integral with the end of the compression member 306.

In the illustrated example of FIG. 3, the tensile members 304 include anchors 308 that are positioned in sockets 310 of the connection node 302. Specifically, the anchors 308 and the sockets 310 form an interference fit to couple the tensile members 304 to the connection node 302 and, in turn, the compression member 306. An opposite end of the tensile members 304 can similarly couple to another connection node on another compression member. Such connections can be repeated and configured to form a desired structure, such as the human foot and lower leg of FIG. 1 and/or the spine of FIG. 2. In the embodiments illustrated herein, an anchor (e.g., the anchor 308) is formed integrally with a body portion of a tensile member (e.g., the tensile member 304). In other embodiments, an anchor (e.g., the anchor 308) may be attached to the body portion of the tensile member (e.g., the tensile member 304).

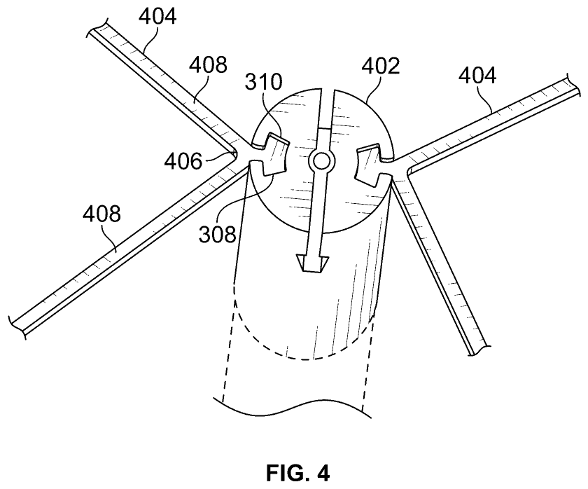

FIG. 4 illustrates another example connection node 402 coupled to tensile members 404 to form a portion of a tensegrity structure, such as the tensegrity structure 100 of FIG. 1 and/or the tensegrity structure 200 of FIG. 2. In the illustrated example of FIG. 4, the tensile members 404 include the anchors 308 positioned in the sockets 310 of the connection node 402, as discussed in association with FIG. 3. In this example, the respective tensile members 404 include a trunk section 406 that extends from the anchor 308. Further, the respective tensile members 404 include two distinct branches 408 that extend from the trunk section 406 in different directions. As such, ends of the respective branches 408 can couple to different connection nodes to form the tensegrity structure. Although the illustrated example of FIG. 4 shows the tensile members 404 having two branches 408, it should be understood that the tensile members 404 can have a different number of branches (e.g., three or more branches) that are fused at the trunk section 406.

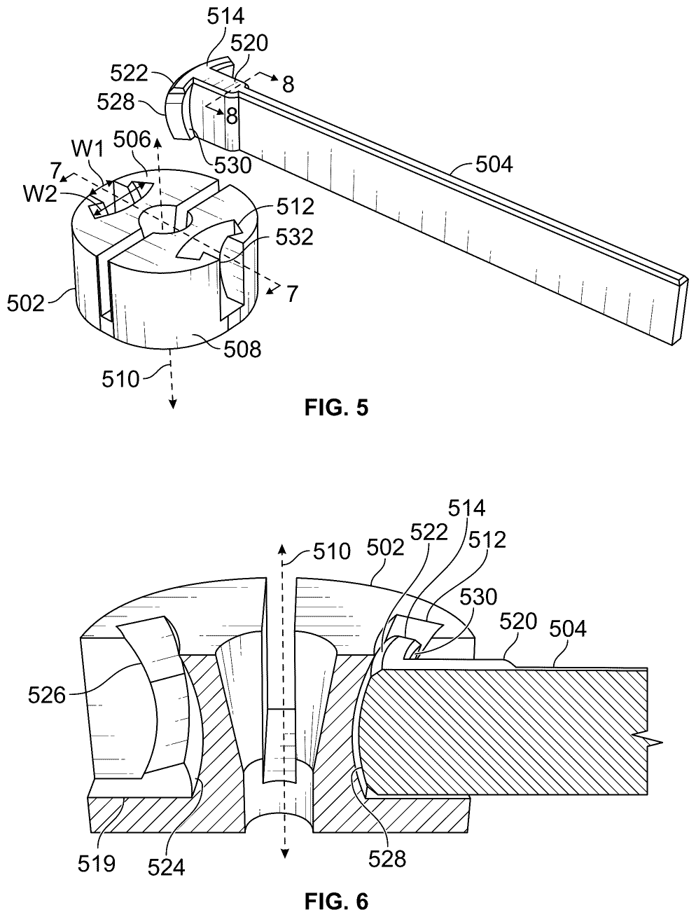

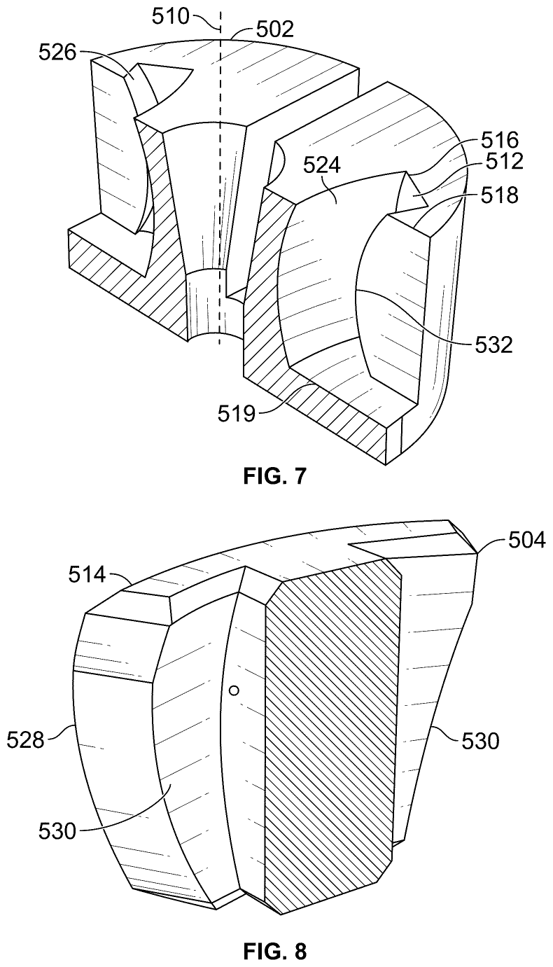

FIG. 5 illustrates an example connection node 502 and an example tensile member 504 to couple to the connection node 502. The connection node 502 and the tensile member 504 form a portion of a tensegrity structure, such as the tensegrity structure 100 of FIG. 1 and/or the tensegrity 200 of FIG. 2. FIG. 6 illustrates an example cross-section of the tensile member 504 coupled to the connection node 502. FIG. 7 illustrates an isolated cross-sectional view of the connection node 502 of FIG. 5 taken along line 7-7. FIG. 8 illustrates an isolated cross-sectional view of the tensile member 504 of FIG. 5 taken along line 8-8.

The connection node 502 includes a first surface 506 and a second surface 508 contiguous with the first surface 506. In this example, the connection node 502 is cylindrically shaped. The first surface 506 is a flat surface defining an end of the cylinder. The second surface 508 is a curved surface that extends between the ends of the cylinder. The connection node 502 defines a central axis 510 orthogonal to the first surface 506 at a center thereof (e.g., a longitudinal axis of the cylinder). The central axis 510 of the connection node 502 can also correspond with a central axis of a compression member to which the connection node 502 couples. Although the connection node 100 of the examples disclosed herein is cylindrically shaped, it should be understood that the connection node 100 and features thereof can be implemented via another shape, such as a cube or prism.

In the illustrated example of FIG. 5, the connection node 502 includes a socket 512 to receive and couple to an anchor 514 defined at an end of the tensile member 504. Specifically, the connection node 502 includes a plurality of the socket 512 evenly distributed around a geometric plane orthogonal to the central axis of the connection node 502. The socket 512 facilitates an interference fit with the anchor 514. The socket 512 includes a first portion 516 having a first width W1. The first portion 516 is defined in the first surface 506 and the second surface 508. The socket 512 also includes a second portion 518 having a second width W2 greater than the first width. The second portion 518 is defined in the first surface 506 and not the second surface 508. Specifically, the first portion 516 and the second portion 518 extend from the first surface 506 to a blind surface 519 of the connection node 502 (e.g., extend from the first surface 506 in a direction parallel to the central axis 510). That is, the blind surface 519 is recessed relative to the first surface 506. In this illustrated embodiment, two of the socket 512 are evenly spaced apart on the connection node 502. In other embodiments, the connection node 502 has more of the socket 512 or fewer of the socket 512. Additionally, in other embodiments, the plurality of the socket 512 may be unevenly spaced apart on the connection node 502.

The socket 512 extends from the second surface 508 towards the central axis 510. Specifically, the second portion 518 is positioned at an end of the first portion 516. Accordingly, the second portion 518 is positioned between the first portion 516 and the central axis 510. As such, the first portion 516 defines a first end of the socket 512, which is the furthest portion of the socket 512 from the central axis 510 in a direction orthogonal to the central axis 510. The second portion 518 defines a second end of the socket 512 (e.g., an end opposite the first end), which is the closest portion of the socket 512 to the central axis 510 in the direction orthogonal to the central axis 510.

The anchor 514 of the tensile member 504 includes a stem 520 and a lateral projection 522 extending from an end of the stem 520. When the tensile member 504 is coupled to the connection node 502, the stem 520 is positioned in the first portion 516 of the socket 512, and the lateral projection 522 is positioned in the second portion 518 of the socket 512. At least one of (i) the stem 520 and the first portion 516 of the socket 512 and/or (ii) the lateral projection 522 and the second portion 518 of the socket 512 form an interference fit (e.g., a pressed fit, a interference fit, etc.) that maintains the connection between the tensile member 504 and the connection node 502 in a tensegrity structure.

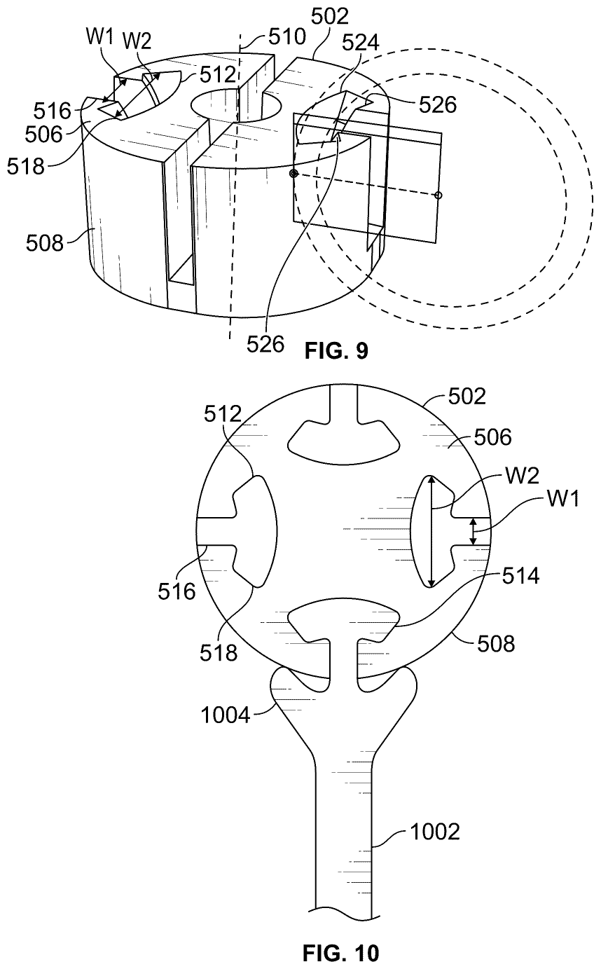

In this example, in addition to a tightness that results from dimensions between the socket 512 and the anchor 514, the interference fit is configured and/or strengthened by mating curvatures of the second portion 518 of the socket 512 and the lateral projection 522 in a geometric plane orthogonal to the first surface 506. FIG. 9 is a schematic view of the curvature of the socket 512 and the lateral projection 522 in the geometric plane orthogonal to the first surface. Additionally, the interference fit is configured and/or strengthened by mating curvatures of the second portion 518 of the socket 512 and the lateral projection 522 in another geometric plane that is parallel to and/or defined by the first surface 506. Specifically, the socket 512 includes a first curved surface 524 and second curved surfaces 526 that include curvature in more than one geometric plane. Similarly, the lateral projection 522 includes a third curved surface 528 and fourth curved surfaces 530 that include curvature in more than one geometric plane. For example, the socket 512 and the lateral projection 522 can have an ovoid shape in a geometric plane coplanar with the central axis 510 of the connection node 502. As such, the lateral projection 522 also has an ovoid shape along a plane coplanar with the central axis of the compression member. In some embodiments, the curvature(s) of the socket 512 and the lateral projection are in the form of an ellipse or semi-circle.

As best seen in FIG. 9, the surfaces 524, 526, 528, 530 can be defined by and/or follow respective radiuses relative to a portion of, or a point on, the tensile member 504 that is positioned outside of the socket 512. The first curved surface 524 of the socket 512 contacts, faces, and/or is adjacent to the third curved surface 528 when the anchor 514 is positioned in the socket 512. Further, the second curved surfaces 526 of the socket 512 contact, face, and/or are adjacent to the fourth curved surfaces 530 of the lateral projection 522.

The surfaces 524, 526, 528, 530 include mating curvature in both the geometric plane orthogonal to the first surface 506 and the geometric plane parallel to or defined by the first surface 506. For example, the curvature of the second curved surfaces 526 in the geometric plane orthogonal to the first surface 506 defines a bulge 532 in the second curved surfaces 526. The bulge 532 defines a portion of the second curved surfaces 526 that is positioned closest to the central axis 510. As best seen in FIGS. 5 and 7, the bulge 532 and the curvature in a lower portion of the fourth curved surfaces 530 prevent the anchor 514 from moving out of the socket 512 in a direction parallel to the central axis 510 out of the socket 512.

Additionally, the curvature of the second curved surfaces 526 and the fourth curved surfaces 530 in the geometric plane parallel to or defined by the first surface 506 helps evenly distribute forces from the fourth curved surfaces 530 across the second curved surfaces 526. As such, the curvature helps reduce a stress localization in the lateral projection 522 proximate the stem 520 that would otherwise result from a planar orientation of the surfaces 526, 530. Thus, the curvature increases an amount of tension that the tensile member 504 can withstand (e.g., without a rupture between the lateral projection 522 and the stem 520). In other embodiments, the first curved surface 524 and the third curved surface 528 are planar (e.g., straight, level, etc.).

In the illustrated examples of FIGS. 5, 6, and/or 8, the stem 520 includes a tapered profile to increase the tightness of the fit between the stem 520 and the first portion 516 of the socket 512 closer to the lateral projection 522 and the second portion 518. In some embodiments, the stem 520 includes a tapered profile to increase the tightness of the fit between the stem 520 and the first portion 516 of the socket 512 closer to the first surface 506. In some embodiments, the first portion 516 of the socket 512 also includes one or more tapered profile(s) that mate with the tapered profile(s) of the stem 520. The tapered profile(s) can facilitate an easier (e.g., more tolerant) fit between the stem 520 and the first portion 516 of the socket 512. Additionally, the tapered profile(s) can guide a user to position the lateral projection 522 and the stem 520 in a preferred orientation when coupling the tensile member 504 to the connection node 502. For instance, the tapered profile(s) can prevent the lateral projection 522 and the stem 520 from being inserted into the socket 512 in a certain (e.g., unpreferred) position, such as a position that might otherwise result in twisting of the tensile member 504 along a span thereof. Prior tensegrity structures utilize a fastener to enable the connection between a connection node and a tensile member to be maintained when the tensile member is placed in tension and, thus, encounters a force that pulls the tensile member away from the connection node.

Advantageously, by configuring the lateral projection 522 and the second portion 518 of the socket 512 to form the interference fit, the connection node 502 and the tensile member 504 of FIG. 5 remove the need for another fastener and help facilitate easy coupling and/or uncoupling between the tensile member 504 and the connection node 502.

FIG. 10 illustrates another example tensile member 1002 including the anchor 514 positioned in the socket 512 of the connection node 502. Additionally, the tensile member 1002 includes a hugging projection 1004 (e.g., a hugging ferrule, wings, etc.) to further secure the connection between the tensile member 1002 and the connection node 502. The hugging projection 1004 extends from a portion of the stem 520 positioned outside of the socket 512. Specifically, the hugging projection 1004 contacts the second surface 508 of the connection node 502. The contact provides an additional source of friction between the tensile member 1002 and the connection node 502 to help secure and maintain the anchor 514 in the socket 512. Additionally, the hugging projection 1004 can serve as a handle for a user to grasp when coupling and/or uncoupling the tensile member 1002 to/from the connection node 502. In some embodiments, the hugging projection 1004 mirrors the lateral projection 522.

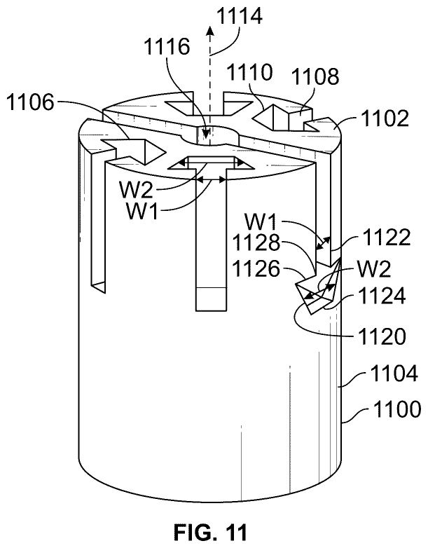

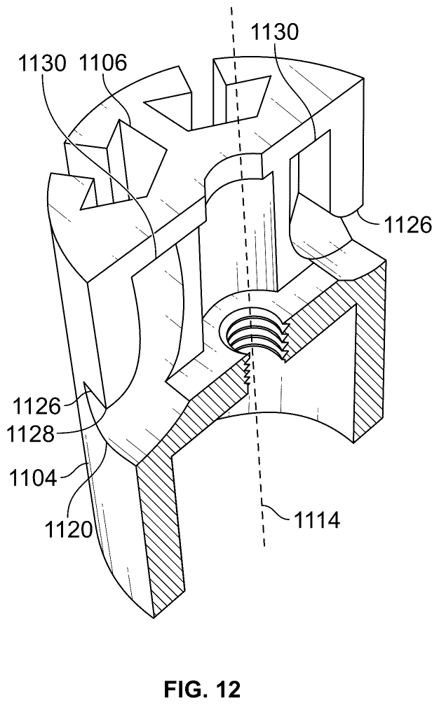

FIGS. 11-14 illustrate another example connection node 1100. FIG. 11 is a perspective view of the connection node 1100. FIG. 12 is a perspective cross-sectional view of the connection node 1100 taken along lines 12-12 of FIG. 11. The connection node 1100 includes a first surface 1102 and a second surface 1104 contiguous with the first surface 1102. In this example, the connection node 1100 is cylindrically shaped. The first surface 1102 is a flat surface defining an end of the cylinder. The second surface 1104 is a curved surface that extends between the ends of the cylinder. Although the connection node 1100 is cylindrically shaped, it should be understood that the connection node 1100 and features thereof can be implemented via another shape, such as a cube or prism.

The connection node 1100 includes a first socket 1106 to receive and couple to an end (e.g., an anchor) of a tensile member. Specifically, the first socket 1106 facilitates an interference fit with the end of the tensile member. The first socket 1106 includes a first portion 1108 having a first width W1. The first portion 1108 is defined in and extends from the first surface 1102 and the second surface 1104. The first socket 1106 also includes a second portion 1110 having a second width W2 greater than the first width. The second portion 1110 is defined in and extends from the first surface 1202 and not the second surface 1104. Specifically, the first portion 1108 and the second portion 1110 extend from the first surface 1102 to a blind surface (not shown) of the connection node 1100 (e.g., extend in a direction parallel to the central axis 510). That is, the blind surface is recessed relative to the first surface 1102.

The first socket 1106 extends from the second surface 1104 towards a central axis 1114 of the connection node 1100. Specifically, the second portion 1110 is positioned at an end of the first portion 1108. Accordingly, the second portion 1110 is positioned between the first portion 1108 and the central axis 1114. As such, the first portion 1108 defines a first end of the first socket 1106, which is the furthest portion of the first socket 1106 from the central axis 1112 in a direction orthogonal to the central axis 1114. The second portion 1110 defines a second end of the socket 1106 (e.g., an end opposite the first end), which is the closest portion of the first socket 1106 to the central axis 1114 in a direction orthogonal to the central axis 1114. In this illustrated embodiment, four of the first socket 1106 are evenly spaced apart on the connection node 1100. In other embodiments, the connection node 1100 has more of the first socket 1106 or fewer of the first socket 1106. Additionally, in other embodiments, the plurality of the first socket 1106 may be unevenly spaced apart on the connection node 1100.

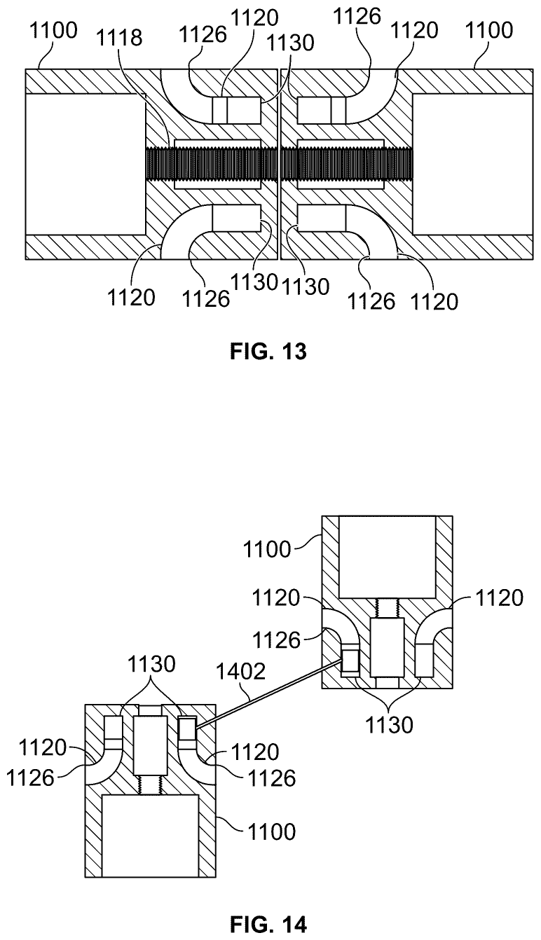

The connection node 1100 also includes a hole 1116 defined along the central axis 1114. In this example, a portion of the hole 1116 includes threads to enable a fastener to couple to the connection node 1100. For example, the fastener can be a tensioning screw. In some examples, the fastener couples the connection node 1100 to a compression member. In some examples, the fastener couples the connection node 1100 to another connection node. FIG. 13 is a cross-sectional view of respective ones of the connection node 1102 coupled via a fastener 1118 positioned in and extending through the holes 1116 of the connection nodes 1100.

The connection node 1100 also includes a second socket 1120 to receive an end (e.g., an anchor) of another tensile member. FIG. 14 is a cross-sectional view of respective ones of the connection node 1100 and a tensile member 1402 coupled to the respective second sockets 1120 of the connection nodes 1102. Similar to the first socket 1106, the second socket 1120 includes a first portion 1122 having the first width W1 and a second portion 1124 having the second width W2. As the first portions 1108, 1122 and the second portions 1110, 1124 have the different sockets 1106, 1120 have the same widths W1, W2, the same tensile member can be used to couple to the different sockets 1106, 1120, which can reduce a quantity of different parts needed to form a tensegrity structure.

The second portions 1110, 1124 have a trapezoidal cross-sectional shape and are configured to position a longer side of the trapezoid proximate the first portions 1108, 1122. As such, the configuration of the second portions 1110, 1124 increases a contact surface area between the sockets 1106, 1120 and the tensile members to reduce a stress concentration in the surfaces that results from counteracting the tension in the tensile members positioned in the sockets 1106, 1120.

The first portion 1122 and the second portion 1124 are defined in and extend from the second surface 1104. The second portion 1124 is defined at an end of the first portion 1122. A path that the second portion 1124 follows is J-shaped or half-U-shaped. That is, at the second surface 1104, a first end 1126 of the second portion 1124 is adjacent to and extends from a first end 1128 of the first portion 1122 in the direction parallel to the central axis 1114. The second portion 1124 of the second socket 1120 extends from the first end 1126 at the second surface 1104 towards the central axis 1114 and then towards an end of the connection node 1100 (e.g., in a direction parallel to the central axis 1114 towards the first surface 1102 or an end opposite the first surface 1102). Accordingly, a second end 1130 of the second portion 1124 of the second socket 1120 is defined at a blind surface of the connection node 1100. The first portion 1122 of the second socket 1120 extends from the second surface 1104 towards the central axis 1114 to the second portion 1124. Additionally, the first portion 1122 of the second socket 1120 extends in the direction parallel to the central axis 1114. In this illustrated embodiment, two of the second socket 1120 are evenly spaced apart on the connection node 1100. In other embodiments, the connection node 1100 has more of the second socket 1120 or fewer of the second socket 1120. Additionally, in other embodiments, the plurality of the second socket 1120 may be unevenly spaced apart on the connection node 1100.

The first socket 1106 and the second socket 1120 enable the connection node 1100 to accommodate a variety of tensile member couplings to enable the connection node 1100 to help the tensile members configure a variety of shapes. Thus, the connection node 1100 can be utilized in a wide variety of tensegrity structures. Although not discussed in connection with FIGS. 5-10, it should be understood that the connection node 502 of FIGS. 5-6 and 8-10 can include second sockets similar to the second socket 1120 of the connection node 1100 of FIGS. 11-14. In such examples, the second sockets of the connection node 502 match the path followed by the second socket 1120 in the connection node 1100 with a different cross-sectional profile to accommodate the lateral projection 522 of the tensile members 504.

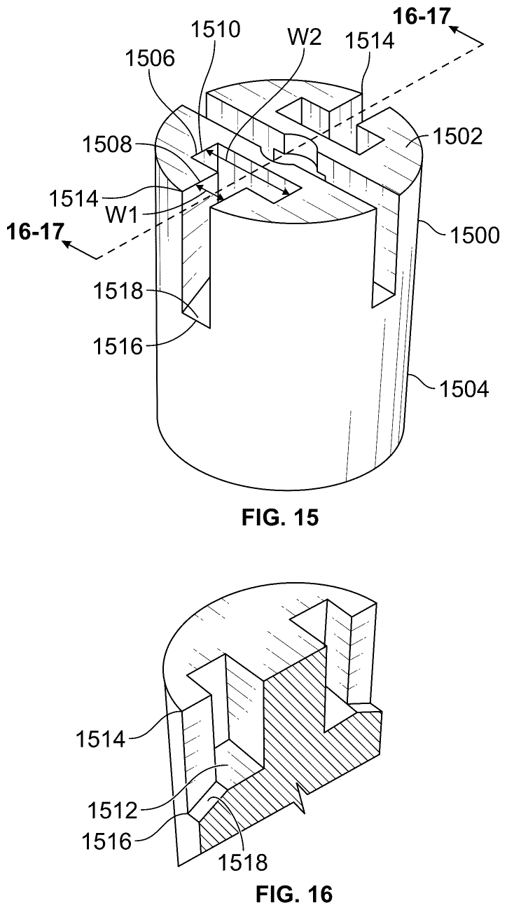

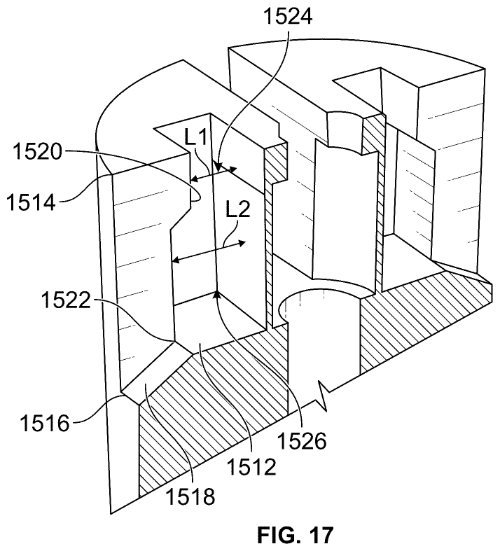

FIGS. 15-17 illustrate another example connection node 1500. FIG. 15 illustrates an isolated, perspective view of another example connection node 1500. FIG. 16 illustrates a first example cross-sectional view of the connection node 1500 taken along line 16-16. FIG. 17 illustrates a second example cross-sectional view of the connection node 1500 taken along line 17-17. That is, FIGS. 16 and 17 are representative of different embodiments of the connection node 1500 for which the differences can be viewed via the cross-sections taken along the lines 16-16 and 17-17.

The connection node 1500 includes a first surface 1502 and a second surface 1504 contiguous with the first surface 1502. In this example, the connection node 1500 is cylindrically shaped. The first surface 1502 is a flat surface defining an end of the cylinder. The second surface 1504 is a curved surface that extends between the ends of the cylinder. Although the connection node 1500 is cylindrically shaped, it should be understood that the connection node 1500 and features thereof can be implemented via another shape, such as a cube or prism.

The connection node 1100 includes a socket 1506 to receive and couple to an end (e.g., an anchor) of a tensile member. Specifically, the socket 1506 facilitates an interference fit with the end of the tensile member. The socket 1506 includes a first portion 1508 having a first width W1. The first portion 1508 is defined in and extends from the first surface 1502 and the second surface 1504. The socket 1506 also includes a second portion 1510 having a second width W2 greater than the first width W1. The second portion 1510 is defined in and extends from the first surface 1502 and not the second surface 1504. Specifically, the second portion 1510 extends from the first surface 1502 to a blind surface 1512 of the connection node 1500 (e.g., extend in a direction parallel to the central axis 510). That is, the blind surface 1512 is recessed relative to the first surface 1102. In this example, the socket 1506 is T-shaped in a geometric plane orthogonal to a central axis 1516 of the connection node 1500. In this illustrated embodiment, two of the socket 1506 are evenly spaced apart on the connection node 1500. In other embodiments, the connection node 1500 has more of the socket 1506 or fewer of the socket 1506. Additionally, in other embodiments, the plurality of the socket 1506 may be unevenly spaced apart on the connection node 1500.

The first portion 1508 of the socket 1506 includes a first end 1514 defined at the first surface 1502. The first portion 1508 of the socket 1506 also includes a second end 1516 defined in and/or extending from the second surface 1504. The second end 1516 includes a slanted surface 1518 that slants away from the first surface 1502 with increased separation from the central axis 1516. As such, the slanted surface 1518 enables access to an area of the first portion 1508 of the socket 1506 between the tensile member positioned therein and the slanted surface 1518 to facilitate easier removal of the tensile member when decoupling from the connection node 1500 is desired. Although not discussed in connection with FIGS. 5-14, it should be understood that the connection node 502 of FIGS. 5-6 and 8-10 and the connection node 1100 of FIGS. 11-14 can include the slanted surface 1518 at ends of the first portions 516, 1108, 1122 of the sockets 512, 1106, 1120 to facilitate easier removal of the tensile members positioned in the sockets 512, 1106, 1120. Although in the illustrated embodiment, the second end 1516 includes the slanted surface 1518 to facilitate easier removal of the tensile member from the socket 1506, the second end 1516 could alternatively include a recess defined in the second surface 1504 instead of the slanted surface 1518 to provide easier access to the tensile member.

As best seen in FIG. 17, the second portion 1510 of the socket 1506 can include a snap-fit overhang 1516. Specifically, the snap-fit overhang 1516 extends from the first surface 1502 towards the blind surface 1512 of the second portion 1510 of the socket 1506 opposite the first surface 1502. The snap-fit overhang 1516 defines a first length L1 (e.g., a distance in a direction orthogonal to the second width W2 and the central axis 1516) in a first section 1520 of the second portion 1510 of the socket 1506. A second section 1522 of the second portion 1510 of the socket 1506 that extends from the first section 1520 to the blind surface 1512 has a second length L2 greater than the first length L1. In some embodiments, the snap-fit overhang 1516 tapers from the second length L2 to the first length L1 as the second portion 1510 moves closer to the first surface 1502.

As such, the snap-fit overhang 1516 can facilitate a snap-fit with the end of the tensile member. Specifically, the tensile member compresses and encounters elastic deformation as it moves past the snap-fit overhang 1516 before returning to form (i.e., expanding in the second section 1522. As a result, the snap-fit overhang 1516 extends over and is aligned with a surface of the tensile member in the second section 1522 that faces a same direction as the first surface 1502 to prevent the tensile member from moving towards the first surface 1502 and, in turn, secure the tensile member in the socket 1506. Although not discussed in connection with FIGS. 5-14, it should be understood that the connection node 502 of FIGS. 5-6 and 8-10 and the connection node 1100 of FIGS. 11-14 can include the snap-fit overhang 1516 in the second portions 518, 1110, 1124 of the sockets 512, 1106, 1120 to facilitate a snap-fit that secures the tensile members in the sockets 512, 1106, 1120. In some examples, the connection node 1500 does not include the snap-fit overhang 1516, as shown in FIG. 16. In such examples, the interference fit between the connection node 1500 and a tensile member is achieved via a configuration (e.g., dimensions) of the socket 1506 and the corresponding end of the tensile member to be inserted therein.

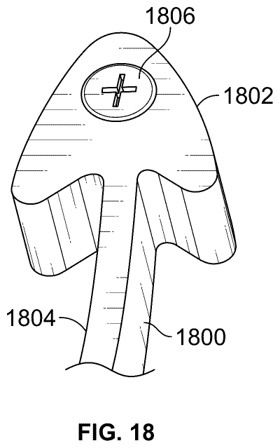

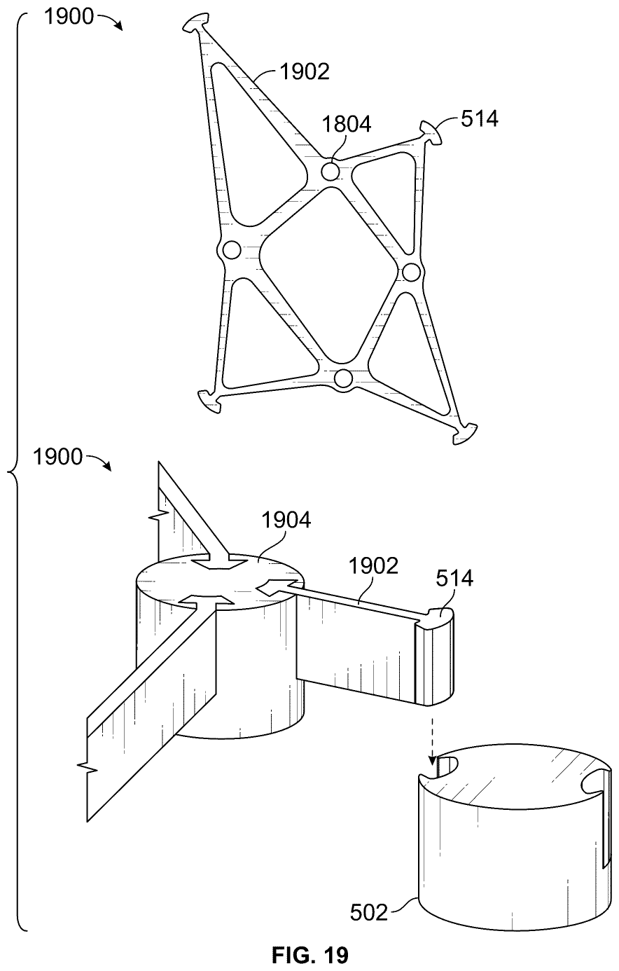

FIG. 18 illustrates a portion of a tensile member 1800 including an anchor 1802 extending from a stem 1804. The anchor 1802 includes an orifice in which a fastener 1806 (e.g., a screw, an individual tensioner) is positioned to secure the tensile member 1800 and/or configure a magnitude of tension therein.

FIG. 19 illustrates an example tensile web 1900 including tensile branches 1902 integral with end caps 1904. The tensile web 1900 enables simpler manufacture/assembly of a relatively larger portion of a tensile structure when the configuration of the portion is predetermined. In some examples, the end caps 1904 define ends of compression member that couple to the tensile branches 1902. In some examples, the end caps 1904 define connection nodes and include sockets to receive ends of other tensile members, as discussed above. Although the example tensile web 1900 has a certain number of tensile branches 1902, end caps 1904, and anchors 514, it should be understood that a tensile web can have a different quantity of tensile branches 1902, end caps 1904, and anchors 514.

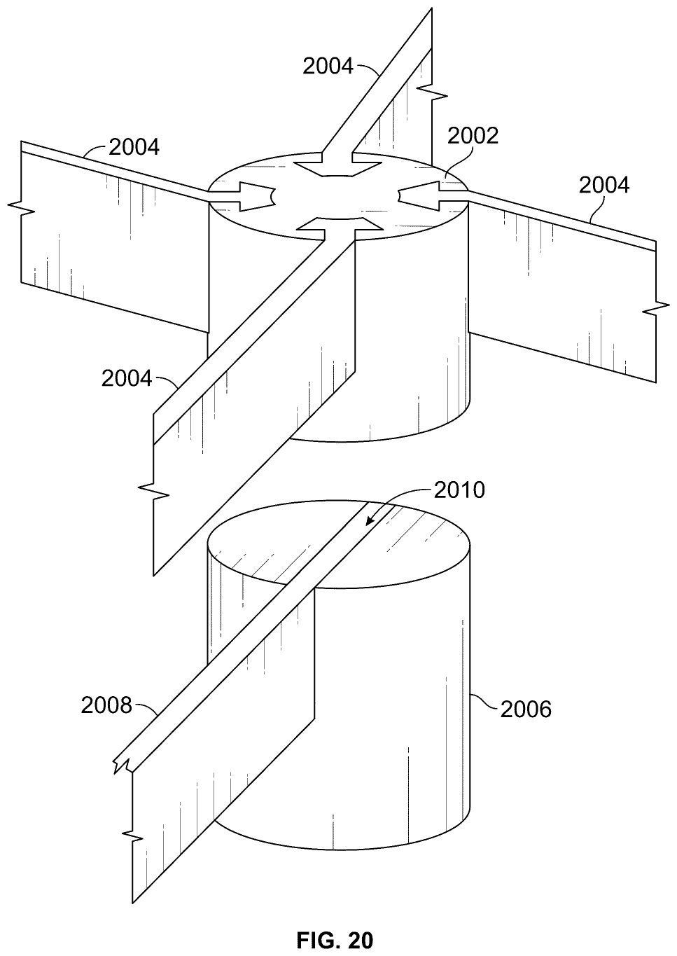

FIG. 20 illustrates an example floating connection node 2002 that is held in place via tensile members 2004 that couple thereto. Thus, the tensile members 2004 hold the connection node 2002 in place like an assembly jig. In some examples, additional tensile members 2004 can then couple to the connection node 2002 while the tensile members 2004 hold the connection node in place. As shown, holding the connection node 2002 in place via the tensile members 2004 enables the connection node 200 to be separated from a compression member 2006. Accordingly, the compression member 2006 can include another connection configuration to couple to a tensile member 2008, such as a slot 2008 through which the tensile member 2008 extends, as shown in FIG. 20.

The foregoing examples of tensile members, compression members, and connection nodes can be used with tensegrity structures. Although each example tensile member, compression member, and/or connection node disclosed above has certain features, it should be understood that it is not necessary for a particular feature of one embodiment of a tensile member, compression member, and/or connection node to be used exclusively with that embodiment. Instead, any of the features described above and/or depicted in the drawings can be combined with any of the embodiments, in addition to or in substitution for any of the other features of those embodiments. Features of one embodiment are not mutually exclusive to features of another embodiment. Instead, the scope of this disclosure encompasses any combination of any of the features.

Example tensegrity structures and components thereof are disclosed herein. Further examples and combinations thereof include the following:

A tensegrity structure comprising a compression member having a central axis, a tensile member including an anchor, and a connection node comprising a plurality of sockets, the connection node attached to an end of the compression member, wherein the plurality of sockets is evenly distributed across a first surface of the connection node around a first geometric plane orthogonal to the central axis of the compression member, wherein each of the plurality of sockets is configured to receive the anchor, wherein each of the plurality of sockets includes curvature in a second geometric plane orthogonal to the first surface.

The tensegrity structure of any preceding clause, wherein each socket has an ovoid shape along a plane coplanar with the central axis of the compression member.

The tensegrity structure of any preceding clause, wherein each socket has a t-shape along the plane orthogonal to the central axis of the compression member.

The tensegrity structure of any preceding clause, wherein each socket extends from the first surface of the connection node to a blind surface within the connection node.

The tensegrity structure of any preceding clause, wherein the connection node is transverse to the orthogonal plane, wherein the tensile member is included in the socket, and wherein an accessory is positioned along the central axis.

The tensegrity structure of any preceding clause, wherein the connection node transverse to the orthogonal plane includes a snap-fit overhang of the receiving socket which tapers a length of a portion of the socket from a first length to a second length greater than the first length, wherein the first length is positioned between the second length and a third geometric plane defined by the first surface.

The tensegrity structure of any preceding clause, wherein the snap-fit overhang of the receiving socket allows for an interference fit connection with the anchor that eliminates the need for additional fastening methods while allowing other tensile spans to be attached and detached without affecting the other tensile spans.

The tensegrity structure of any preceding clause, wherein the connection node includes a second surface contiguous with the first surface, wherein the respective sockets include a first portion having a first width and a second portion having a second width greater than the first width, the first portion of the socket defined in the first surface and the second surface, the second portion of the socket defined in the first surface and not the second surface, wherein the greater width is measurable in a geometric plane parallel to the first surface.

The tensegrity structure of any preceding clause, wherein the sockets are first sockets, wherein the connection node includes a second socket, wherein the second socket is defined in the second surface of the connection node and does not extend to the first surface.

The tensegrity structure of any preceding clause, wherein an end of the first portion of the socket includes a slanted surface relative to a geometric plane defined by the first surface, and wherein the slanted surface is contiguous with the second surface.

The tensegrity structure of any preceding clause, wherein the tensile member includes a first end and a second end opposite the first end, wherein the anchor is defined at the first end, wherein the tensile member includes a projection defined between the first end and the second end, wherein the projection contacts a second surface of the connection node.

A connection node for a tensegrity structure, the connection node comprising a first surface, a second surface contiguous with the first surface, and a socket to receive an end of a tensile member and enable the tensile member to couple to the connection node via an interference fit, wherein the socket includes a first portion having a first width and a second portion having a second width greater than the first width, the first portion of the socket defined in the first surface and the second surface, the second portion of the socket defined in the first surface and not the second surface, wherein the first width and the second width is measurable in a geometric plane parallel to the first surface.

The connection node of any preceding clause, wherein the socket includes a first end defined at the first face and a second end opposite the first end, the second end including an angled portion extending from the second face at least partially towards the first surface.

The connection node of any preceding clause, wherein the socket includes a first end defined at the first face and a second end opposite the first end, and wherein at least one of the first portion or the second portion of the socket is tapered towards the second end.

The connection node of any preceding clause, further including a snap-fit overhang extending from the first surface to cause the second portion of the socket to have a first length at the first surface and a second length separated from the first surface.

The connection node of any preceding clause, wherein the second portion of the socket is connected to an end of the first portion of the socket opposite the second surface.

The connection node of any preceding clause, wherein the socket is a first socket, further including a second socket that extends through the second surface and not the first surface.

The connection node of any preceding clause, wherein the second socket includes a first end and a second end defined in the second surface, wherein the second end includes a greater width than the first end.

The connection node of any preceding clause, wherein the first end is positioned between the second end and an edge of the second surface that is contiguous with the first surface.

A connection node comprising a first surface, a second surface contiguous with the first surface, and a socket to receive an end of a tensile member and enable the tensile member to couple to the connection node via an interference fit, wherein the socket includes a first portion having a first width and a second portion having a second width greater than the first width, the first portion of the socket defined in the first surface and the second surface, the second portion of the socket defined in the first surface and not the second surface, wherein the second portion of the socket includes curvature in a geometric plane orthogonal to a central axis of the connection node, and wherein ends of the second portion of the socket bend towards the first portion of the socket.

What is claimed is:

1. A tensegrity structure comprising of:
a compression member having a central axis;
a tensile member including an anchor; and
a connection node comprising a plurality of sockets, the connection node attached to an end of the compression member, wherein the plurality of sockets is evenly distributed across a first surface of the connection node around a first geometric plane orthogonal to the central axis of the compression member, wherein each of the plurality of sockets is configured to receive the anchor, wherein each of the plurality of sockets includes curvature in a second geometric plane orthogonal to the first surface.

2. The tensegrity structure of claim 1, wherein each socket has an ovoid shape along a plane coplanar with the central axis of the compression member.

3. The tensegrity structure of claim 2, wherein each socket has a t-shape along the plane orthogonal to the central axis of the compression member.

4. The tensegrity structure of claim 3, wherein each socket extends from the first surface of the connection node to a blind surface within the connection node.

5. The tensegrity structure of claim 1, wherein the connection node is transverse to the orthogonal plane, wherein the tensile member is included in the socket, and wherein an accessory is positioned along the central axis.

6. The tensegrity structure of claim 1, wherein the connection node transverse to the orthogonal plane includes a snap-fit overhang of the receiving socket which tapers a length of a portion of the socket from a first length to a second length greater than the first length, wherein the first length is positioned between the second length and a third geometric plane defined by the first surface.

7. The tensegrity structure of claim 6, wherein the snap-fit overhang of the receiving socket allows for an interference fit connection with the anchor that eliminates the need for additional fastening methods while allowing other tensile spans to be attached and detached without affecting the other tensile spans.

8. The tensegrity structure of claim 1, wherein the connection node includes a second surface contiguous with the first surface, wherein the respective sockets include a first portion having a first width and a second portion having a second width greater than the first width, the first portion of the socket defined in the first surface and the second surface, the second portion of the socket defined in the first surface and not the second surface, wherein the greater width is measurable in a geometric plane parallel to the first surface.

9. The tensegrity structure of claim 8, wherein the sockets are first sockets, wherein the connection node includes a second socket, wherein the second socket is defined in the second surface of the connection node and does not extend to the first surface.

10. The tensegrity structure of claim 8, wherein an end of the first portion of the socket includes a slanted surface relative to a geometric plane defined by the first surface, and wherein the slanted surface is contiguous with the second surface.

11. The tensegrity structure of claim 1, wherein the tensile member includes a first end and a second end opposite the first end, wherein the anchor is defined at the first end, wherein the tensile member includes a projection defined between the first end and the second end, wherein the projection contacts a second surface of the connection node.

12. A connection node for a tensegrity structure, the connection node comprising:
a first surface;
a second surface contiguous with the first surface; and
a socket to receive an end of a tensile member and enable the tensile member to couple to the connection node via an interference fit, wherein the socket includes a first portion having a first width and a second portion having a second width greater than the first width, the first portion of the socket defined in the first surface and the second surface, the second portion of the socket defined in the first surface and not the second surface, wherein the first width and the second width is measurable in a geometric plane parallel to the first surface.

13. The connection node of claim 12, wherein the socket includes a first end defined at the first face and a second end opposite the first end, the second end including an angled portion extending from the second face at least partially towards the first surface.

14. The connection node of claim 12, wherein the socket includes a first end defined at the first face and a second end opposite the first end, and wherein at least one of the first portion or the second portion of the socket is tapered towards the second end.

15. The connection node of claim 12, further including a snap-fit overhang extending from the first surface to cause the second portion of the socket to have a first length at the first surface and a second length separated from the first surface.

16. The connection node of claim 12, wherein the second portion of the socket is connected to an end of the first portion of the socket opposite the second surface.

17. The connection node of claim 12, wherein the socket is a first socket, further including a second socket that extends through the second surface and not the first surface.

18. The connection node of claim 17, wherein the second socket includes a first end and a second end defined in the second surface, wherein the second end includes a greater width than the first end.

19. The connection node of claim 18, wherein the first end is positioned between the second end and an edge of the second surface that is contiguous with the first surface.

20. A connection node comprising:
a first surface;
a second surface contiguous with the first surface; and
a socket to receive an end of a tensile member and enable the tensile member to couple to the connection node via an interference fit, wherein the socket includes a first portion having a first width and a second portion having a second width greater than the first width, the first portion of the socket defined in the first surface and the second surface, the second portion of the socket defined in the first surface and not the second surface, wherein the second portion of the socket includes curvature in a geometric plane orthogonal to a central axis of the connection node, and wherein ends of the second portion of the socket bend towards the first portion of the socket.
